(19) United States
(12) Patent Application Publication
(10) Pub. No.: US 2017/0277419 A1
(43) Pub. Date: Sep. 28, 2017

(54) Method and Electronic Device for Replying to a Message

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/331,317

(22) Filed: Oct. 21, 2016

Related U.S. Application Data
(63) Continuation of application No. PCT/CN2016/096422, filed on Aug. 23, 2016.

(30) Foreign Application Priority Data
Mar. 25, 2016 (CN) 2016101804377

(51) Int. Cl. G06F 3/0488; H04L 12/58

(52) U.S. Cl. CPC G06F 3/04883; H04L 51/24; G06F 3/04842

(57) ABSTRACT

Disclosed are a method and electronic device for replying to a message. On the one hand, according to some embodiments of the present disclosure, a terminal acquiring an operation information of a user at an edge touch area of a terminal if a new message is received by the terminal; and executing a shortcut reply operation to the received new message according to the operation information of the user at the edge touch area of the terminal. Therefore, a user can quickly complete replying to a message only by simple operation at an edge touch area of a terminal without any other operations on a screen, thereby solving the problem of the prior art that users fail to rapidly reply to messages, saving the operation time of replying messages, and improving the efficiency of replying message.

### CROSS REFERENCE TO RELATED APPLICATIONS

This application is a continuation of International Application No. PCT/CN2016/096422, filed Aug. 23, 2016, and claims priority to Chinese Patent Application No. 2016101804377, filed Mar. 25, 2016, the disclosures of which are hereby incorporated in their entirety by reference.

### TECHNICAL FIELD

The disclosure relates to the field of communication technology, and particularly relates to a method and electronic device for replying to a message.

### BACKGROUND

At present, people's life is filled with the applications, such as QQ, WeChat, SMS, etc. When a user needs to reply to a message if the user receives such message, the user needs to unlock his terminal first, then open the message which needs to be replied to, edit a reply text, and finally click the sending button to send the reply text, so as to complete sending the new message.

In the process of implementing the present disclosure, the inventor found that the prior art at least has the following problems:

As the people are increasingly busy in life and work, users often need to reply to received messages, but the replying manner in the prior art involves complex operation, consumes a lot of operation time and reduces the efficiency of replying to a message.

### SUMMARY

The present disclosure provides a method and electronic device for replying to a message, so as to solve the problem of the prior art that the replying manner involves tedious operation, consumes a lot of operation time and reduces the efficiency of replying to a message.

In a first aspect, the embodiments of the disclosure provide a method for replying to a message, including:

acquiring an operation information of a user at an edge touch area of a terminal if a new message is received by the terminal; and

executing a shortcut reply operation to the received new message according to the operation information of the user at the edge touch area of the terminal.

According to the above-mentioned aspect and any possible implementation way, an implementation way is further provided. The user operation information in the edge touch area of the terminal includes:

an operation information generated by a sliding operation of the user at the edge touch area of the terminal; or,

an operation information generated by a clicking operation of the user at the edge touch area of the terminal; or,

an operation information generated by a pressing operation of the user at the edge touch area of the terminal.

According to the above-mentioned aspect and any possible implementation way, an implementation way is further provided. The executing of a shortcut reply operation to the received new message according to the operation information of the user at the edge touch area of the terminal includes:

detecting whether the operation information is the designated operation information of a shortcut reply message or not; and

executing the shortcut reply operation to the received new message if the operation information is detected to be the designated operation information of the shortcut reply message.

According to the above-mentioned aspect and any possible implementation way, an implementation way is further provided. The executing of a shortcut reply operation to the received new message comprises:

determining a reply text corresponding to the operation information of the user at the edge touch area of the terminal, according to a preset corresponding relation between the operation information and the reply text; or, determining the corresponding reply text according to the application for receiving the new message in the terminal; and

sending the determined reply text.

According to the above-mentioned aspect and any possible implementation way, an implementation way is further provided. The executing of a shortcut reply operation to the received new message comprises:

displaying at least one candidate text, and taking one candidate text selected by the user from the at least one candidate text as a reply text; and

sending the reply text

One of the above technical solutions has the following beneficial effects:

According to some embodiments of the present disclosure, if a new message is received by a terminal, the terminal acquires an operation information of a user at an edge touch area of a terminal, and then executes a shortcut reply operation to the received new message according to the operation information of the user at the edge touch area of the terminal. Therefore, the present disclosure can achieve a shortcut reply to a message by the edge touch area. A user can quickly complete replying to a message only by simple operation at an edge touch area of a terminal without any other operations on a screen, thereby avoiding complex and tedious operation process during replying to a message in the prior art, saving the operation time, improving the efficiency of replying message, and meeting the user's needs of shortcut for replying to a message.

In order to achieve the above object of the disclosure, in yet another aspect, the embodiments of the present disclosure provide an electronic device, including: at least one processor; and a memory communicably connected with the at least one processor for storing instructions executable by the at least one processor, wherein execution of the instructions by the at least one processor causes the at least one processor to execute the method provided in various aspects mentioned above.

In order to achieve the above object of the disclosure, in yet another aspect, the embodiments of the present application further provide a non-transitory computer-readable storage medium storing executable instructions that, when executed by an electronic device, cause the electronic device to execute the method provided in various aspects mentioned above.

In order to achieve the above object of the disclosure, in yet another aspect, the embodiments of the present disclosure provide a computer program product including a computer program stored in non-transitory computer-readable storage medium, where the computer program includes program instructions that, when executed by a computer, enable the computer to execute the method provided in various aspects mentioned above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow diagram of a method for replying to a message provided by some embodiments of the present disclosure;

FIG. 2 is a schematic structure diagram of a terminal provided by some embodiments of the present disclosure;

FIG. 3 is a schematic diagram of a hardware structure of an electronic device for executing a method for replying to a message provided by some embodiments of the present disclosure.

### DETAILED DESCRIPTION

In order to better understand the technical solutions of the present disclosure, the embodiments of the present disclosure are described in detail in conjunction with the drawings thereinafter.

It shall be clear that only parts of the embodiments, instead of all embodiments, of the present disclosure are presented. Based on the embodiments of the present disclosure, all other embodiments concluded by the person skilled in the art without making inventive labor fall within the scope of protection of the present disclosure.

As used in the embodiments of the present disclosure, the terms are intended to describe specific embodiments only, and are not intended to limit the present disclosure. The singular forms of “a”, “the” and “this” used in the embodiments and appended claims of the present disclosure are also intended to include plural forms, unless the context clearly indicates other meanings.

It will be appreciated that the term “and/or” is used herein just to describe the relationship of associated objects, and means to include three relationships. For example, A and/or B means that A exists alone, or both A and B exist, or B exists alone. In addition, the character “/” herein generally means that there is a relationship of “or” between front and rear associated objects.

Depending on the context, as used herein, the word “if” can be interpreted as “at the time of . . . ” or “when . . . ” or “in response to determination” or “in response to detection”. Similarly, depending on the context, the phrase “if it is determined” or “if it is detected (stated conditions or events)” may be interpreted as “when determining” or “in response to determination” or “when detecting (stated conditions or events)” or “in response to detection (stated conditions or events).”

### Embodiment 1

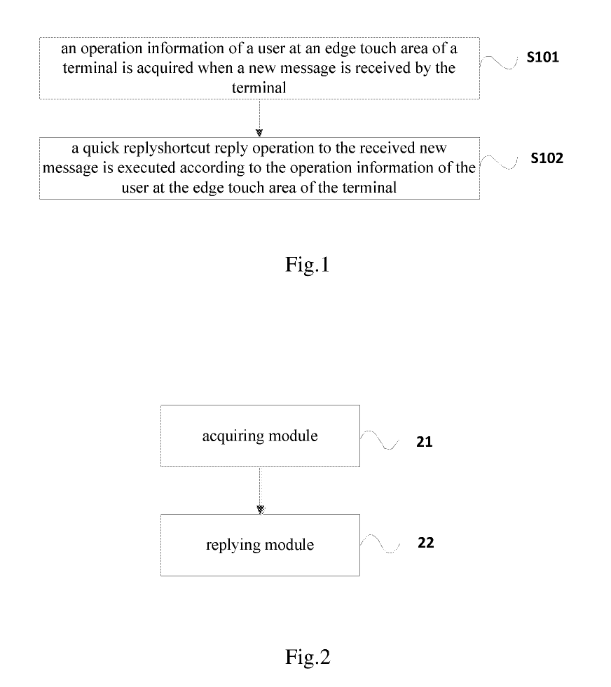

The embodiment of the present disclosure provides a method for replying to a message. FIG. 1 is a flow schematic diagram of a method for replying to a message provided by some embodiments of the present disclosure. As shown in the fig., the method includes the following steps S101-S102:

S101, an operation information of a user at an edge touch area of a terminal is acquired when a new message is received by the terminal.

It shall be noted that, the terminal involved in the embodiments of the present disclosure may include, but is not limited to, a personal computer (PC), a personal digital assistant (PDA), a wireless handheld device, a tablet computer, a mobile phone, an MP3 player, an MP4 player, etc.

Specifically, according to some embodiments of the present disclosure, the operation information of a user at an edge touch area of a terminal includes, but is not limited to, the following information:

an operation information generated by a sliding operation of the user at the edge touch area of the terminal; or,

an operation information generated by a clicking operation of the user at the edge touch area of the terminal; or,

an operation information generated by a pressing operation of the user at the edge touch area of the terminal.

It will be appreciated that, the edge touch control means to provide touch input through an edge or side border of the terminal and track the clicking, sliding or pressing operation of a finger on the terminal edge, so as to realize the control to the terminal.

The edge touch area of a terminal may be an area on a side surface of the terminal accessible to a user's thumb when the user naturally holds the terminal, and the side surface of the terminal may include other four side surfaces except the front surface and back surface.

According to some embodiments of the present disclosure, an edge touch area of a terminal may be implemented using physical buttons, virtual buttons, sensors or screens, etc.

For example, if a terminal uses a curved screen, the edge touch area of the terminal can be implemented using the edge screen of the curved screen. Illustrated with a capacitive touch screen as an example, when a user's finger touches the edge touch screen, the capacitance of touch spot will change, so that the frequency of an oscillator connected with the capacitor changes, the touch position can be determined by measuring the change of oscillator frequency, and then the operation information of a user at an edge touch area of a terminal can be acquired.

Or, for another example, for a terminal without using a curved screen, its edge touch area can be implemented using physical buttons, virtual buttons or sensors.

For example, if there are physical buttons for volume regulation on the edge of a terminal, description is provided with the physical button for volume control on the terminal as an example: when a user's finger presses a physical button for volume control, the terminal will determine whether the user presses the volume up button or presses the volume down button. Similarly, when a user presses the edge touch area, the terminal can acquire the operation information of a user at an edge touch area of a terminal.

For another example, if there are virtual buttons with certain functions on the edge of a terminal, and the virtual buttons are capacitive virtual buttons, the terminal determines which virtual button is touched by a user through the capacitance of the capacitive virtual button. Specifically, when a user touches a capacitive virtual button, a capacitor is formed between the finger and an electrode slice in the capacitive virtual button, and the terminal determines the user touch position by detecting the change of the capacitance, thereby determining which virtual button is touched by the user, and then acquiring the operation information of a user at an edge touch area of a terminal.

For another example, if there are sensors having certain functions on the edge of a terminal, the sensors on the terminal, e.g. a pressure sensor, are taken as an example: when a user presses the pressure sensor, a semiconductor deformation force is formed on the surface of the pressure sensor sheet, and a piezoelectric impedance effect is caused by sheet deformation due to pressing, so that the impedance change is converted into an electrical signal. After acquiring the electrical signal, the terminal can determine which pressure sensor or which position on the pressure sensor is pressed by the user, so as to determine the pressure sensor with which function pressed by the user, and then acquires the operation information of a user at an edge touch area of a terminal. In addition, a sensor with certain functions on the edge of a terminal may also be a light sensor.

Specifically, acquiring an operation information of a user at an edge touch area of a terminal may include: acquiring an operation information of a user at an effective area of the edge touch area of the terminal. Only by operation at the effective area, the purpose of replying to a message can be achieved.

For example, if a terminal uses a curved screen, when the operation information of the user is acquired using the edge screen of the curved screen in the edge touch area of the terminal, the effective area of the edge screen is an edge area of the screen that can be clicked or touched by a user's thumb when the user naturally holds the terminal.

S102: a shortcut reply operation to the received new message is executed according to the operation information of the user at the edge touch area of the terminal.

Specifically, a user can execute a shortcut reply operation to the received new message of the terminal by operation at the edge touch area of the terminal.

According to some embodiments of the present disclosure, executing a shortcut reply operation to the received new message according to the operation information of the user at the edge touch area of the terminal may include, but is not limited to, the following operations:

detecting whether the operation information is the designated operation information of a shortcut reply message or not; and

executing the shortcut reply operation to the received new message if the operation information is detected to be the designated operation information of the shortcut reply message.

Specifically, detection of whether the operation information is the designated operation information of the shortcut reply message or not is intended to judge whether the user operation in the effective area can trigger executing shortcut reply operation or not.

Where, the designated operation information of the shortcut reply message may be set in advance according to actual needs.

For example, according to some embodiments of the present disclosure, executing a shortcut reply operation to the received new message may include, but is not limited to, the following methods:

1) determining a reply text corresponding to the operation information of the user at the edge touch area of the terminal, according to a preset corresponding relation between the operation information and the reply text; and sending the determined reply text.

2) determining the corresponding reply text according to the application for receiving the new message in the terminal; and sending the determined reply text.

3) displaying at least one candidate text, and taking one candidate text selected by the user from all candidate texts as a reply text; and sending the reply text.

According to some embodiments of the present disclosure, a terminal can preset corresponding relation between the operation information and the reply text, which is illustrated by taking a touch screen as the edge touch area of the terminal as an example. For example, a terminal presets that upward sliding of a user at the effective area of an edge touch area of the terminal corresponds to a text A. When the terminal needs to reply to a new received message, the terminal detects that a user slides upward at the effective area of the edge touch area of the terminal, the terminal finds the preset corresponding relation between the operation information and the reply text, determines the text A as the reply text, and adds the text A to an editor. The user may send the text A after simply editing it, or may also directly send the text A as required.

Or, according to some embodiments of the present disclosure, a terminal may also determine the reply text based on different applications for receiving new message. For example, the terminal can preset reply texts respectively corresponding to QQ, WeChat, SMS and other applications, and execute shortcut reply by a specified operation of the user at the effective area of the edge touch area of the terminal. Therefore, when the terminal receives a QQ message, and detects that a user has performed a specified operation at the effective area of the edge touch area of the terminal, the terminal adds the preset reply text corresponding to the QQ message to an editor. The user may send the reply text after simply editing it, or may also directly send the reply text as required.

Or, according to some embodiments of the present disclosure, a terminal can preset at least one candidate text corresponding to identical operation information, or, can respectively preset at least one corresponding candidate text according to the application for receiving a new message. Therefore, when the terminal receives a new message and detects that the operation information of the user at the edge touch area of the terminal is designated operation information of the shortcut reply message, the terminal displays at least one candidate text corresponding to the operation information according to the operation information of the user, then receives a candidate text selected by the user from the at least one candidate texts, then takes the selected candidate text as the reply text based on the user's selection, and finally adds the determined reply text into the editor. The user may send the reply text after simply editing it, or may also directly send the reply text as required.

For example, a terminal can preset that upward sliding of a user at the effective area of an edge touch area of the terminal corresponds to a text A, a text B and a text C. When the terminal needs to reply to a new received message and detects that a user slides upward at the effective area of the edge touch area of the terminal, the terminal finds the preset corresponding relation between the preset operation information and the reply text, determines the text A, the text B and the text C as the candidate texts, displays the text A, the text B and the text C for the user, determines the text B as the reply text according to the user's selection, and adds the text B to the editor. The user may send the text B after simply editing it, or may also directly send the text B as required.

Or, for another example, a terminal can further preset text 1 and text 2 corresponding to WeChat application, and trigger shortcut reply by a designated operation of the user at the effective area of the edge touch area of the terminal. Therefore, when the terminal receives a WeChat message and detects that a user has performed a designated operation at the effective area of the edge touch area of the terminal, the terminal determines the text 1 and the text 2 as the candidate texts, displays the text 1 and the text 2 for the user, determines the text 1 as the reply text according to the user's selection, and adds the text 1 to the editor. The user may send the text 1 after simply editing it, or may also directly send the text 1 as required.

The technical solutions of the embodiments of the present disclosure have the following beneficial effects:

According to some embodiments of the present disclosure, if a new message is received by a terminal, the terminal acquires an operation information of a user at an edge touch area of a terminal, and then executes a shortcut reply operation to the received new message according to the operation information of the user at the edge touch area of the terminal. Therefore, the present disclosure can achieve shortcut reply to a message by an edge touch area. A user can quickly complete replying to a message only by simple operation at an edge touch area of a terminal without any other operations on a screen, thereby avoiding complex and tedious operation process during replying to a message in the prior art, saving the operation time, improving the efficiency of replying message, and meeting the user's needs of the shortcut for replying to a message.

### Embodiment 2

Based on a replying message method provided by the above embodiment 1, the embodiments of the present disclosure further provide an embodiment of a terminal for realizing various steps and methods provided in the embodiments of the above methods. FIG. 2 is a schematic diagram of a structure of a terminal provided by some embodiments of the present disclosure. As shown in FIG. 2, the terminal includes:

an acquiring module 21, for acquiring an operation information of a user at an edge touch area of a terminal if a new message is received by the terminal; and

a replying module 22, for executing a shortcut reply operation to the received new message according to the operation information of the user at the edge touch area of the terminal.

Specifically, the operation information of the user at the edge touch area of the terminal comprises:

an operation information generated by a sliding operation of the user at the edge touch area of the terminal; or,

an operation information generated by a clicking operation of the user at the edge touch area of the terminal; or,

an operation information generated by a pressing operation of the user at the edge touch area of the terminal.

Specifically, the replying module 22 is specifically used for:

detecting whether the operation information is the designated operation information of a shortcut reply message or not; and

executing the shortcut reply operation to the received new message if the operation information is detected to be the designated operation information of the shortcut reply message.

Furthermore, the replying module 22 for executing a shortcut reply to the received new message is specifically used for:

determining a reply text corresponding to the operation information of the user at the edge touch area of the terminal, according to a preset corresponding relation between the operation information and the reply text; or, determining the corresponding reply text according to the application for receiving the new message in the terminal; and

sending the determined reply text.

Or, the replying module 22 for executing shortcut reply to the received new message is specifically used for:

displaying at least one candidate text, and taking one candidate text selected by the user from the at least one candidate text as a reply text; and

sending the reply text.

Various units or modules in the present embodiment are capable of executing the method shown in FIG. 1. Please refer to relevant description of FIG. 1 for the parts that are not described in detail in the present embodiment.

The technical solutions of the embodiments of the present disclosure have the following beneficial effects:

According to some embodiments of the present disclosure, if a new message is received by a terminal, the acquiring module of the terminal acquires an operation information of a user at an edge touch area of a terminal, and then the replying module of the terminal executes a shortcut reply operation to the received new message according to the operation information of the user at the edge touch area of the terminal. Therefore, the present disclosure can achieve shortcut reply to a message by an edge touch area. A user can quickly complete replying to a message only by simple operation at an edge touch area of a terminal without any other operations on a screen, thereby avoiding complex and tedious operation process during replying to a message in the prior art, saving the operation time, improving the efficiency of replying to a message, and meeting the user's needs of shortcut replying message.

### Embodiment 3

The embodiments of the present application provide a non-transitory computer-readable storage medium storing executable instructions that can execute the method in any above embodiment of methods.

### Embodiment 4

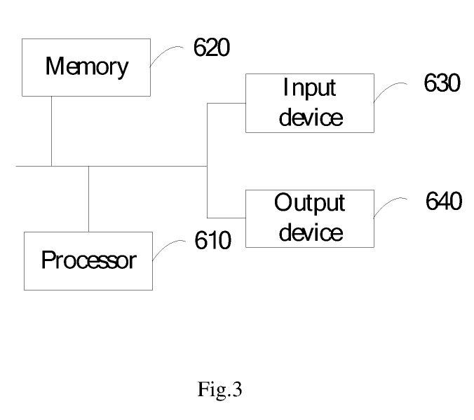

FIG. 3 is a schematic diagram of a hardware structure of an electronic device for executing a method for replying to a message provided by some embodiments of the present application. As shown in FIG. 3, the device includes one or more processors 610 and a memory 620. A case of one processor 610 is taken as an example in FIG. 3. The device may further include: an input device 630 and an output device 640.

The processor 610, the memory 620, the input device 630 and the output device 640 can be connected through a bus or by other means. A case of bus connection is taken as an example in FIG. 3.

As a non-transitory computer-readable storage medium, the memory 1120 can be used for storing non-transitory software programs, non-transitory computer executable programs and modules. The processor 610 runs non-transitory software programs, instructions and modules stored in the memory 620, so as to execute various function applications and data processing of the electronic device, i.e., implementing the processing method in the embodiments of the above methods.

The memory 620 may include a program storage area and a data storage area, wherein the program storage area can store an operating system or application programs required by at least one function, and the data storage area can store data, etc. In addition, the memory 620 may include a high-speed random access memory, and may further include a non-transitory memory, such as at least one disk memory device, a flash memory device, or other non-transitory solid-state memories. In some embodiments, the memory 620 may optionally include remote memories relative to the processor 610, and these remote memories can be connected to the processing unit over network. Examples of the above networks include, but are not limited to the Internet, intranets, LANs, mobile communication networks and combinations thereof.

The input device 630 receives input number or character information, and generates signal input. The output device 640 may include display devices such as a display screen.

The one or more modules are stored in the memory 620, and the following are executed when the modules are executed by the one or more processors 610:

acquiring an operation information of a user at an edge touch area of a terminal if a new message is received by the terminal; and

executing a shortcut reply operation to the received new message according to the operation information of the user at the edge touch area of the terminal.

The above product can execute the method provided by the embodiments of the present application, and has corresponding function modules for executing the method and beneficial effects. The technical details not described in the embodiment in detail are available with reference to the method provided by the embodiments of the disclosure.

The electronic device according to the embodiments of the present disclosure exists in a variety of forms, including but not limited to the following devices:

Mobile communication devices: this type of device is featured with a mobile communication function, and is mainly used for providing voice and data communication. These terminals include: a smartphone (e.g. iPhone), a multimedia phone, a functionality phone, and a low-end phone, and the like.

Ultra-mobile PC devices: this type of device belongs to the range of personal computers, and is provided with computation and processing functions, and typically has a mobile internet characteristic. These terminals include: PDA, MID and UMPC device, and the like, such as iPad.

Portable entertainment devices: this type of device can display and play multimedia contents. This type of device includes: voice and audio players (such as iPod), handheld game players, e-books, intelligent toys and portable vehicle navigation device.

Servers: devices providing computing service. The server components include a processor, hard drives, an internal memory, a system bus, etc. Structures of the servers are similar to that of a general computer. But because of the need of providing highly reliable service, the requirements in respect of processing capacity, stability, reliability, security, scalability, manageability, etc. are very high.

Other electronic devices having data interaction functions.

The device embodiments described above are merely exemplary, wherein units described as separated components can be or cannot be separated physically, components displayed as units can be or cannot be physical units, namely can be located in one place, or can be distributed on multiple network units. The object of the solution of the embodiments can be achieved by selecting part or all of modules according to practical demands.

Based on the above description of the embodiments, it can be clearly appreciated by person skilled in the art that the embodiments can be implemented in a way of combination of software and a universal hardware platform or through hardware certainly. Based on such understanding, the nature of the above-mentioned technical solution or its part making contribution to relevant technology can be embodied in form of software. The computer software product can be stored in a computer-readable storage medium, such as ROM/RAM, a disk, CD, etc. and comprises a plurality of instructions for enabling one set of computer equipment (which may be a personal computer, a server or network equipment, etc.) to execute the method described in all embodiments or in part of an embodiment.

Finally, it should be noted that the above-mentioned embodiments are only used for explaining the technical solution of this application but not for limiting it. Even though this application has been described in detail with reference to the aforesaid embodiments, it should be understood that person skilled in the art still can modify the technical solutions disclosed in the above-mentioned embodiments or make equivalent substitutions to part of technical features; and these modifications or substitutions will not depart the corresponding technical solutions essentially from the spirit and scope of the technical solutions of all embodiments of this application.

### INDUSTRIAL APPLICABILITY

According to the method and terminal for replying to a message provided by the embodiments of the present disclosure, operation information of a user at an edge touch area of the terminal is acquired when a new message is received by the terminal, and a shortcut reply operation to the received new message is executed according to the operation information of the user at the edge touch area of the terminal, so as to achieve beneficial effects.

What is claimed is:

1. A method for replying to a message, executed by a terminal, the method comprising:
acquiring an operation information of a user at an edge touch area of a terminal if a new message is received by the terminal; and
executing a shortcut reply operation to the received new message according to the operation information of the user at the edge touch area of the terminal.

2. The method according to claim 1, wherein the operation information of the user at the edge touch area of the terminal comprises:
an operation information generated by a sliding operation of the user at the edge touch area of the terminal; or,
an operation information generated by a clicking operation of the user at the edge touch area of the terminal; or,
an operation information generated by a pressing operation of the user at the edge touch area of the terminal.

3. The method according to claim 1, wherein executing the shortcut reply operation to the received new message according to the operation information of the user at the edge touch area of the terminal comprises:
detecting whether the operation information is the designated operation information of a shortcut reply message or not; and
executing the shortcut reply operation to the received new message if the operation information is detected to be the designated operation information of the shortcut reply message.

4. The method according to claim 1, wherein executing the shortcut reply operation to the received new message comprises:
determining a reply text corresponding to the operation information of the user at the edge touch area of the terminal, according to a preset corresponding relation between the operation information and the reply text; or, determining the corresponding reply text according to the application for receiving the new message in the terminal; and
sending the determined reply text.

5. The method according to claim 1, wherein executing the shortcut reply operation to the received new message comprises:
displaying at least one candidate text, and taking one candidate text selected by the user from the at least one candidate text as a reply text; and
sending the reply text.

6. An electronic device, comprising:
at least one processor; and
a memory communicably connected with the at least one processor for storing instructions executable by the at least one processor, wherein execution of the instructions by the at least one processor causes the at least one processor to:
acquire an operation information of a user at an edge touch area of a terminal if a new message is received by the terminal; and
execute a shortcut reply operation to the received new message according to the operation information of the user at the edge touch area of the terminal.

7. The electronic device according to claim 6, wherein the operation information of the user at the edge touch area of the terminal comprises:
an operation information generated by a sliding operation of the user at the edge touch area of the terminal; or,
an operation information generated by a clicking operation of the user at the edge touch area of the terminal; or,
an operation information generated by a pressing operation of the user at the edge touch area of the terminal.

8. The electronic device according to claim 6, wherein executing the shortcut reply operation to the received new message according to the operation information of the user at the edge touch area of the terminal comprises:
detecting whether the operation information is the designated operation information of a shortcut reply message or not; and
executing the shortcut reply operation to the received new message if the operation information is detected to be the designated operation information of the shortcut reply message.

9. The electronic device according to claim 6, wherein executing the shortcut reply operation to the received new message comprises:
determining a reply text corresponding to the operation information of the user at the edge touch area of the terminal, according to a preset corresponding relation between the operation information and the reply text; or, determining the corresponding reply text according to the application for receiving the new message in the terminal; and
sending the determined reply text.

10. The electronic device according to claim 6, wherein executing the shortcut reply operation to the received new message comprises:
displaying at least one candidate text, and taking one candidate text selected by the user from the at least one candidate text as a reply text; and
sending the reply text.

11. A non-transitory computer-readable storage medium storing executable instructions that, when executed by an electronic device with a touch-sensitive display, cause the electronic device to:
acquire an operation information of a user at an edge touch area of a terminal if a new message is received by the terminal; and
execute a shortcut reply operation to the received new message according to the operation information of the user at the edge touch area of the terminal.

12. The non-transitory computer-readable storage medium according to claim 11, wherein the operation information of the user at the edge touch area of the terminal comprises:
an operation information generated by a sliding operation of the user at the edge touch area of the terminal; or,
an operation information generated by a clicking operation of the user at the edge touch area of the terminal; or,
an operation information generated by a pressing operation of the user at the edge touch area of the terminal.

13. The non-transitory computer-readable storage medium according to claim 11, wherein executing the shortcut reply operation to the received new message according to the operation information of the user at the edge touch area of the terminal comprises:
detecting whether the operation information is the designated operation information of a shortcut reply message or not; and
executing the shortcut reply operation to the received new message if the operation information is detected to be the designated operation information of the shortcut reply message.

14. The non-transitory computer-readable storage medium according to claim 11, wherein executing the shortcut reply operation to the received new message comprises:
determining a reply text corresponding to the operation information of the user at the edge touch area of the terminal, according to a preset corresponding relation between the operation information and the reply text; or, determining the corresponding reply text according to the application for receiving the new message in the terminal; and
sending the determined reply text.

15. The non-transitory computer-readable storage medium according to claim 11, wherein executing the shortcut reply operation to the received new message comprises:
displaying at least one candidate text, and taking one candidate text selected by the user from the at least one candidate text as a reply text; and
sending the reply text.
